(19) United States
(12) Patent Application Publication
(10) Pub. No.: US 2024/0003931 A1
(43) Pub. Date: Jan. 4, 2024

(54) Primordial Function of Life

(71) Applicant: Gary Mirzakhanov, Fernandina Beach, FL (US)

(72) Inventor: Gary Mirzakhanov, Fernandina Beach, FL (US)

(21) Appl. No.: 17/556,088

(22) Filed: Dec. 20, 2021

(51) Int. Cl. G01N 37/00

(52) U.S. Cl. CPC G01N 37/005

(57) ABSTRACT

A method that explains the way how in the history of the universe the first biological cell or cells, that spontaneously appeared in nature, began functioning immediately and properly without having the knowledge and experience to run the life-essential processes.

It is based on logical and mathematical proof that there is a high possibility that the primordial functions of life, somehow were transferred into the cognitive part of the cell right after the cell appeared.

### BACKGROUND OF THE INVENTION

Nowadays, looking around, where plant and animal life, as well as microorganisms, exist everywhere, it is impossible to imagine that at the early stage of the creation of the universe, there was nothing organic on the surface of this and other planets due to the monstrous condition for life that excluded the existence of any living thing.

Scientists hypothesize that all organisms on Earth today were originated from a single cell that existed somewhere 3.5 to 3.8 billion years ago.

The origin of the cell has to do with the origin of life, which began the history of life on Earth. There are several theories about the origin of small molecules that led to life on the early Earth: they may have been carried to Earth on meteorites, or created at deep-sea, or synthesized by lightning in a reducing atmosphere (see Miller-Urey experiment).

All the above and more than that can be found in the different scientific sources, but the theory of how the first cell or molecules could know how to start functioning properly was not provided in any explanations about the cell origin.

It occurred after an incredibly long period of formation of galaxies with the planets. Then an atmosphere formatted on some of the planets where life could arise. And then by the coincidence of chaotic or logical circumstances, the first cell or cells appeared for some negligible fraction of time.

At the very moment of appearance, the cell had to know a lot, because it shall perform an infinite number of processes (algorithms) that are part of each essential function—metabolism, respiration, diffusion, osmosis, active transport.

The cell also had to start consuming what was needed and process it into a vital to continue to live and reproduce, since this is the essence of all living things!

But the cell did not have any previous knowledge which is derivative of experience, and the cell had to start functioning immediately, which involves countless exceptionally intelligent actions, and if one of the processes is wrong—it dies.

The first appeared cell can be compared with an assembled and a turned-on computer with a blank screen, which needs the programs like DOS and MS Windows to start functioning as a real computer.

From all previous statements, we can conclude that the functions of life could not arise in the cell spontaneously out of chaos, and from already existing at that time nonbiological matter, it had to be created by logic.

And finally, what is the function of life? This is a program saturated with vital algorithms and with a given database.

The functions of life were somehow transferred into the cognitive part of the cell right after the cell appeared.

### DESCRIPTION OF THE INVENTION

Turning now to the calculations and more particularly to FIG. 1 that illustrates the indefinitely (∞) high numbers of variations using the permutation method that is based on a minimum of four (4) functions, and a minimum of one thousand (1000) of processes for each function in each cell. But since the first cell or cells first time appeared in the history of the universe, it had no previous experience and knowledge, and therefore, it was not possible that all processes somehow spontaneously could arrange in the proper order from the indefinitely (∞) high numbers of variations.

FIG. 2 proves the previous statement by illustrating an indefinitely (∞) low probability of the proper algorithm that is acceptable for the cell survival, and it is based on the indefinitely (∞) high numbers of variations shown in FIG. 1

Plus, the cell should commence functioning immediately, otherwise, delay and malfunction can have resulted in the death of the cell, and according to the indefinitely high number of permutations, it will take more time, and the chances for the cell to survive without the primordial knowledge will be even lower.

Based on the above statement and the calculations shown on FIG. 1 & FIG. 2, there is an indefinitely low probability that the cell somehow survived. It definitely means that there was a very high possibility that the primordial knowledge, which can be called—The Primordial Functions of Life, was somehow transferred into the cognitive part of the cell right after the cell appeared in nature.

### FIELD OF THE INVENTION

This invention relates to a method of showing that even if the simplest biological structure in the history of nature has ever arisen, it was impossible for them to become the first biological living being without knowing how to function as the cell.

More specifically, this invention relates to a method of proving that the probability of spontaneous correct action of the first cell is zero, and other options should be considered.

### FIGURES

FIG. 1 illustrates the calculus of variations using the permutation method and shows that four functions and a minimum 1000 of processes for each function will prove the definitely (∞) high [4,000 ₄₀₀₀] number of the permutations (variations). Even the computer could not show the indefinitely high numbers of the permutations: a message—“overflow” was on the screen.

FIG. 2 illustrates an indefinitely (∞) low probability [P=1/4,000 ₄₀₀₀] of the right variation for the cell survival which is based on the indefinitely (co) high numbers of variations shown in FIG. 1. Even the computer could not show the indefinitely low probability of an event: a message—“overflow” was on the screen.

### OBJECTS OF THE INVENTION

The aim of the present invention is to disclose a method that explains how in the history of the Universe, the first biological cell or cells that spontaneously appeared in nature began to function immediately and properly, without having the knowledge and experience to control vital processes.

It is an object of this invention to explain that the first cell had to start functioning immediately without any delay and shall function properly because delay and malfunction can have resulted in the death of the cell. The axiom of life says that biological life processes should continue, and if they stop—means the beginning of the process of decomposition and death.

It is an object of this invention to disclose that because the cell has a minimum of four or five functions—metabolism, respiration, diffusion, osmosis, active transport, and each function has a minimum of one thousand processes,—the cell shall have the knowledge and experience to run these processes immediately without any delay and in a proper sequence to survive.

It is also an object of this invention to explain, based on logic, that the cell that just appeared in the history of the universe, had no previous experience and knowledge, and therefore life processes could not spontaneously arrange in the proper order because with four functions, and a minimum of one thousand processes per function, the calculation, using the permutation method, will show the zero probability

It is also an object of this invention to prove that because the cell shall commence functioning immediately, the indefinitely high number of permutations, which means variations of processes, will take more time, which means that this decreases the chances even further for the cell to survive.

It is finally an object of this invention is to show that even with the existing infinitely low probability that the cell can survive, the cell survived, which means that there is an infinitely high possibility that the cell initially knew how to survive, and this knowledge, which can be called The Primordial Functions of Life, were somehow transferred to the cognitive part of the cell immediately after the cell appeared in nature.

I claim:

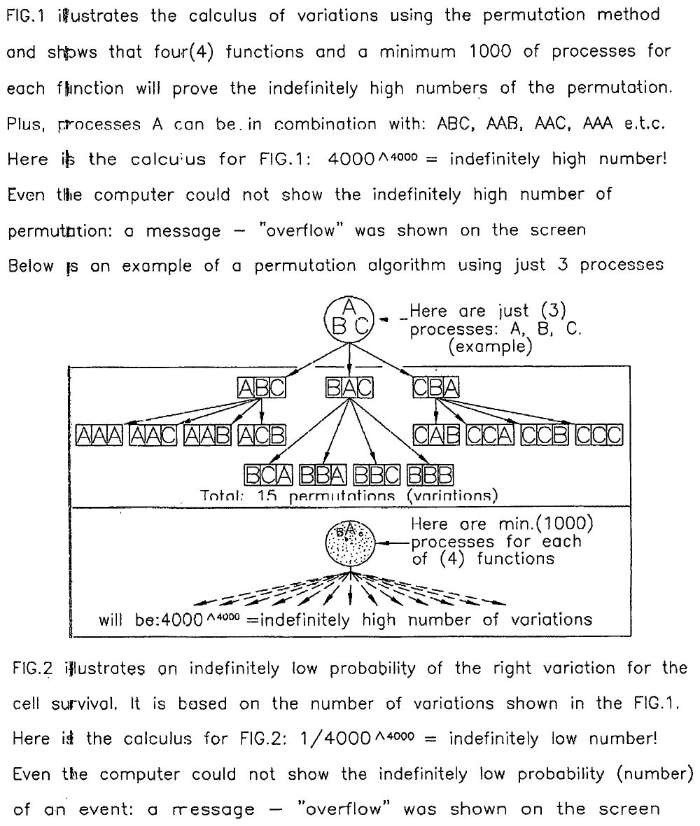

1. When the first cell or cells just appeared in the history of the universe, it had no previous experience and knowledge, and therefore, it was not possible that all processes somehow spontaneously could arrange in the proper order, which evidently follows from the following:
a) if in the history of the universe the first biological cell spontaneously appeared in nature, the cell had to start functioning immediately, without any delay and properly because delay, and a malfunction could have resulted in their death
b) since each cell has a minimum of four functions and each function has a minimum of one thousand processes, the cell shall have the knowledge and experience to run these processes immediately and in a proper sequence to survive in accordance with step (a)
c) referring to step (b), because there are a minimum of four functions and a minimum of one thousand processes per function, and using the permutation method (see FIG. 1), the probability will be indefinitely low or in other words—zero (see FIG. 2)
d) based on step (a) the cell should commence functioning immediately, and according to step (c) the indefinitely high number of permutations will take more time, decreasing the chances even further for the cell to survive without the primordial knowledge
e) based on steps (c) and (d), there was no chance for the cell to survive

2. That based on claim 1 step (c), there was an Indefinitely Low Probability that the cell would survive, but the cell or cells survived, and the life began on a planet, which definitely means that there was a Very High Possibility that the primordial knowledge, which can be called—The Primordial Functions of Life, was somehow transferred into the cognitive part of the cell right after the cell appeared in nature.
